(19) United States
(12) Patent Application Publication
(10) Pub. No.: US 2019/0325003 A1
(43) Pub. Date: Oct. 24, 2019

(54) NOISE REDUCTION APPARATUS AND NOISE SUPPRESSING METHOD

(71) Applicant: Olympus Corporation, Tokyo (JP)

(72) Inventor: Masamitsu FUJIMARU, Tokyo (JP)

(21) Appl. No.: 16/367,094

(22) Filed: Mar. 27, 2019

(30) Foreign Application Priority Data
Apr. 18, 2018 (JP) 2018-079900

(51) Int. Cl. G06F 17/14; G10L 21/0208

(52) U.S. Cl. CPC G06F 17/141; G10L 21/0208

(57) ABSTRACT

A noise reduction apparatus includes: a first converting circuit configured to generate first data by subjecting externally input first audio data to Fourier transform to convert into amplitude data per frequency; a noise-data recording circuit configured to record noise data that has been detected in advance; a subtracting circuit configured to generate second data by subtracting the noise data from the first data; an arithmetic circuit configured to generate third data by synthesizing the first data and the second data; and a second converting circuit configured to generate second audio data by subjecting the third data to inverse Fourier transform.

### CROSS REFERENCES TO RELATED APPLICATIONS

This application is based upon and claims the benefit of priority from Japanese Patent Application No. 2018-079900, filed on Apr. 18, 2018, the entire contents of which are incorporated herein by reference.

### BACKGROUND

The present disclosure relates to a noise reduction apparatus and a noise suppressing method.

As a method of removing noise superimposed on audio data, a spectrum subtraction method has been known. In this spectrum subtraction method, a subtraction spectrum signal is generated by subtracting what is obtained by multiplying a spectrum signal of noise by a subtraction coefficient from an input spectrum signal based on input audio data, and an output spectrum signal and audio data in which noise is reduced are generated by using this subtraction spectrum signal. However, in the spectrum subtraction method, the subtraction coefficient takes a large value, and depending on a difference in level of voice and noise included in the input audio data, a subtraction resultant is to be zero or smaller. As a result, a large distortion is generated in an output spectrum, and this distortion causes unusual sound, so-called musical noise.

As a method of preventing occurrence of musical noise described above, a technique of preventing occurrence of musical noise by generating audio data by using a subtraction spectrum signal and background noise obtained in advance has been known. The subtraction spectrum signal is generated by subtracting a signal obtained by multiplying a spectrum signal of noise by a predetermined coefficient while sequentially changing the value from an input spectrum signal based on input audio data (for example, JP-A-2014-44313).

### SUMMARY

A noise reduction apparatus according to one aspect of the present disclosure includes: a first converting circuit configured to generate first data by subjecting externally input first audio data to Fourier transform to convert into amplitude data per frequency; a noise-data recording circuit configured to record noise data that has been detected in advance; a subtracting circuit configured to generate second data by subtracting the noise data from the first data; an arithmetic circuit configured to generate third data by synthesizing the first data and the second data; and a second converting circuit configured to generate second audio data by subjecting the third data to inverse Fourier transform.

The above and other features, advantages and technical and industrial significance of this invention will be better understood by reading the following detailed description of presently preferred embodiments of the disclosure, when considered in connection with the accompanying drawings.

### BRIEF DESCRIPTION OF THE DRAWINGS

FIG. 1 is a block diagram illustrating a functional configuration of a noise reduction apparatus according to a first embodiment;

FIG. 2 is a flowchart illustrating an overview of processing performed by the noise reduction apparatus according to the first embodiment;

FIG. 3 is a diagram illustrating audio data before and after noise removal by the noise reduction apparatus according to the first embodiment;

FIG. 4 is a block diagram illustrating a functional configuration of an electronic device according to a second embodiment;

FIG. 5 is a schematic diagram illustrating an example of noise data that is recorded in a noise-data recording unit according to the second embodiment;

FIG. 6 is a schematic diagram illustrating another example of noise data recorded in the noise-data recording unit according to the second embodiment;

FIG. 7 is a schematic diagram illustrating another example of noise data recorded in the noise-data recording unit according to the second embodiment;

FIG. 8 is a flowchart illustrating an overview of processing performed by the electronic device according to the second embodiment;

FIG. 9 is a timing chart of an action performed by the electronic device according to the second embodiment;

FIG. 10 is a schematic diagram of a coefficient that is set to each of first data and second data by a setting unit according to the second embodiment according to the present disclosure, according to volume detected by a volume detecting unit;

FIG. 11 is a schematic diagram illustrating a coefficient according to volume of each of the first data and the second data;

FIG. 12 is a schematic diagram illustrating an arithmetic method of an arithmetic unit according to the second embodiment;

FIG. 13 is a schematic diagram illustrating a coefficient that is set to each of the first data and the second data by a setting unit according to a modification of the second embodiment, according to volume detected by the volume detecting unit;

FIG. 14 is a flowchart illustrating an overview of processing performed by an electronic device according to a third embodiment;

FIG. 15 is a timing chart of an action performed by the electronic device according to the third embodiment;

FIG. 16 is a flowchart illustrating an overview of processing performed by an electronic device according to a fourth embodiment; and

FIG. 17 is a timing chart of an action performed by the electronic device according to a fourth embodiment.

### DETAILED DESCRIPTION OF THE PREFERRED EMBODIMENTS

Forms to implement the present disclosure (hereinafter, “embodiments”) are described in detail below with reference to the drawings. Note that the following embodiments are not intended to limit the present disclosure. Moreover, the respective drawings referred to in the following description only schematically illustrate shapes, sizes, and positional relationships to enable understanding of contents of the present disclosure. That is, the present disclosure is not limited to the shapes, the sizes, and the positional relationships illustrated in the respective drawings.

### First Embodiment

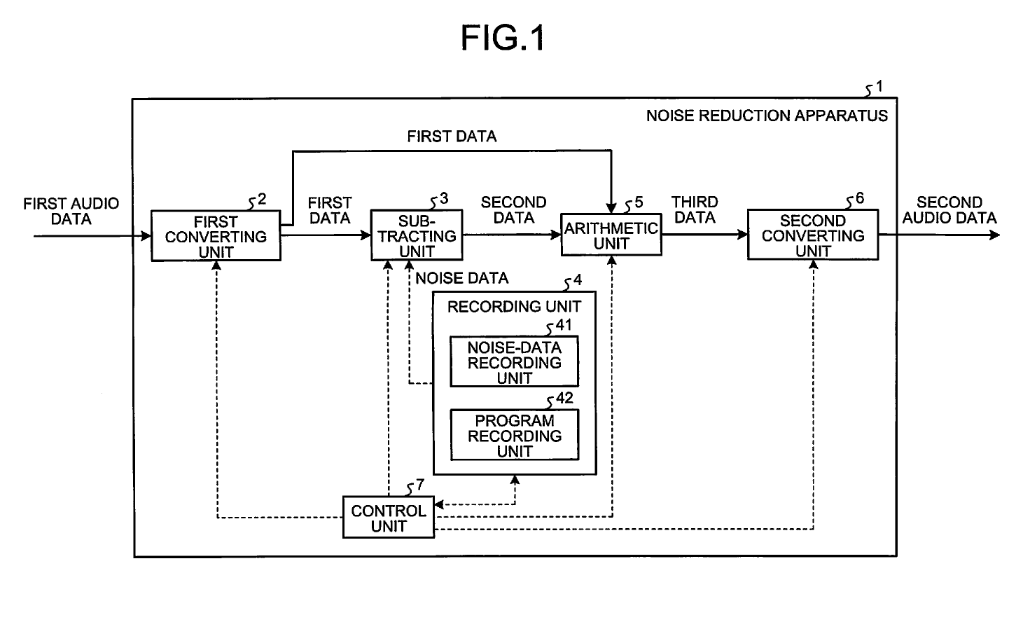

FIG. 1 is a block diagram illustrating a functional configuration of a noise reduction apparatus according to a first embodiment. A noise reduction apparatus 1 illustrated in FIG. 1 may be used for either one of a voice recording device, such as an integrated circuit (IC) recorder, that acquires voice by, for example, a microphone and record it as audio data, and that outputs audio data by a speaker or the like; an imaging device that records moving image data or image data that are generated by an imaging device, such as a charge coupled device (CCD) and a complementary metal oxide semiconductor (CMOS), a speaker, and the like, and that displays a moving image corresponding to the moving image data; a headphone that reproduces audio data from an external device to output; a reproduction device that reproduces audio data transmitted from an external server device through a network; a server device that records and distributes audio data transmitted from an external device through a network; and the like.

The noise reduction apparatus 1 illustrated in FIG. 1 includes a first converting unit 2, a subtracting unit 3, a recording unit 4, an arithmetic unit 5, a second converting unit 6, and a control unit 7.

The first converting unit 2 generates first data that is obtained by converting first audio data externally input into amplitude data per frequency by Fourier transform under control of the control unit 7, and outputs this first data to the subtracting unit 3 and the arithmetic unit 5. For example, the first converting unit 2 performs discrete Fourier transform, fast Fourier transform, or the like as the Fourier transform. The first converting unit 2 is constituted of, for example, a discrete Fourier transform circuit, or a fast Fourier transform circuit. In the first embodiment, a case in which the discrete Fourier transform is performed as the Fourier transform is described.

The subtracting unit 3 calculates second data by subtracting noise data recorded in the recording unit 4 from the first data that is input from the first converting unit 2 under control of the control unit 7, and outputs the calculated second data to the arithmetic unit 5. The noise data is statistical data that is acquired by statistic calculation of a result acquired by subjecting audio data that has been acquired in an anechoic condition in advance to the Fourier transform. Specifically, for the noise data, a large value, such as a statistical value (for example, ave+2σ, ave+3σ, ave×1.5, ave×2, max value) that is acquired by performing the Fourier transform on plural pieces of audio data, or the like is chosen so that noise is not left without being subtracted.

The recording unit 4 is constituted of a flash memory, a synchronous dynamic random-access memory (SDRAM), or the like. The recording unit 4 includes a noise-data recording unit 41 that records noise data used for subtraction by the subtracting unit 3, and a program recording unit 42 that records various kinds of programs executed by the noise reduction apparatus 1.

The arithmetic unit 5 performs arithmetic to generate third data by synthesizing the first data input from the first converting unit 2 and the second data input from the subtracting unit 3, and outputs this third data to the second converting unit 6. For example, the arithmetic unit 5 generates the third data by performing arithmetic of synthesizing the first data input from the first converting unit 2 and the second data input from the subtracting unit 3 at a predetermined ratio (for example, 1:1).

The second converting unit 6 generates second audio data by subjecting the third data input from the arithmetic unit 5 to inverse Fourier transform, and outputs it. The second converting unit 6 performs inverse discrete Fourier transform or inverse fast Fourier transform as the inverse Fourier transform. The second converting unit 6 is constituted of, for example, an inverse discrete Fourier transform (IDFT) circuit, or an inverse fast Fourier transform (IFFT) circuit. In the first embodiment, a case in which the inverse discrete Fourier transform is performed as the inverse Fourier transform is described. Note that the first converting unit 2, the subtracting unit 3, the arithmetic unit 5, and the second converting unit 6 may be configured respectively by using a digital signal processing (DSP), an application specific integrated circuit (ASIC), a field programmable gate array (FPGA), or the like, and to exert functions described above by reading the various kinds of programs recorded in the recording unit 4.

The control unit 7 controls respective parts constituting the noise reduction apparatus 1. The control unit 7 is constituted of, for example a DSP, an FPGA, or a central processing unit (CPU).

### Processing of Noise Reduction Apparatus

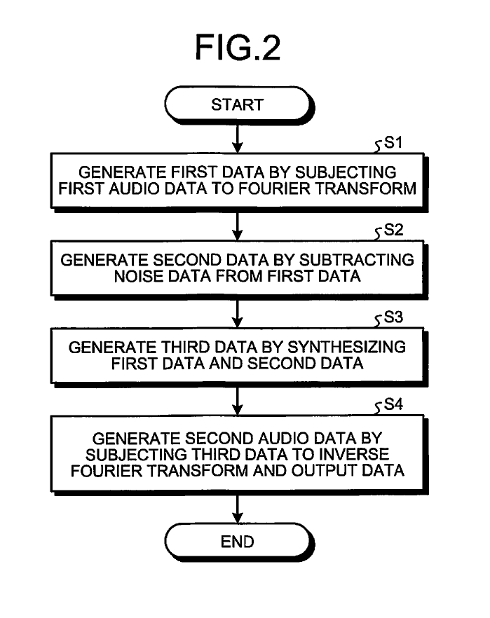

Next, processing performed by the noise reduction apparatus 1 is described. FIG. 2 is a flowchart illustrating an overview of the processing performed by the noise reduction apparatus 1.

As illustrated in FIG. 2, first, the first converting unit 2 generates the first data that is obtained by converting into amplitude data per frequency by subjecting the first audio data externally input to the Fourier transform (step S1).

Subsequently, the subtracting unit 3 generates the second data by subtracting noise data that is recorded in the recording unit 4 from the first data input from the first converting unit 2 (step S2). When a subtraction result takes a negative value, the subtracting unit 3 handles the amplitude as 0.

Thereafter, the arithmetic unit 5 generates the third data by synthesizing the first data input from the first converting unit 2 and the second data input from the subtracting unit 3 (step S3).

Subsequently, the second converting unit 6 generates the second audio data by subjecting the third data input from the arithmetic unit 5 to the inverse Fourier transform, and outputs it (step S4). After step S4, the noise reduction apparatus 1 ends the processing.

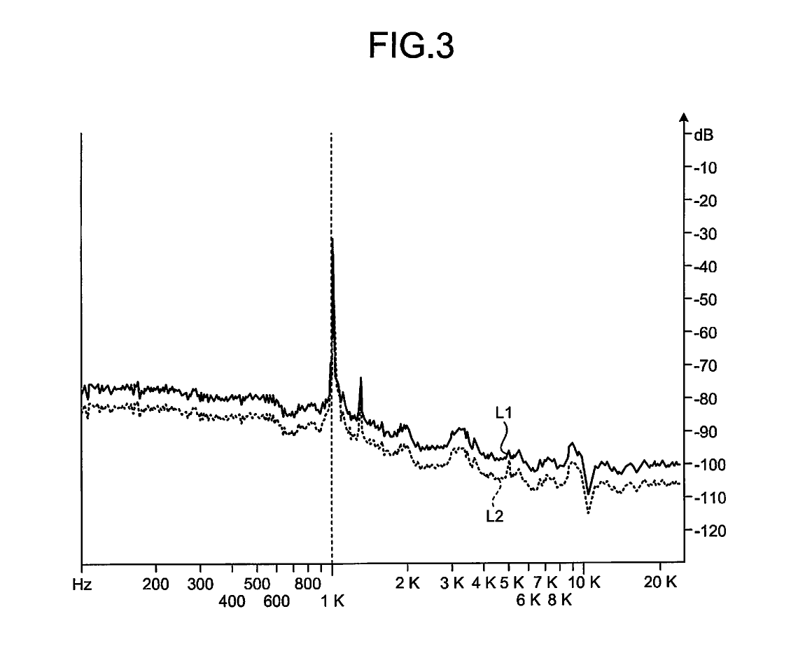

FIG. 3 is a diagram illustrating audio data before and after noise removal by the noise reduction apparatus 1. In FIG. 3, a horizontal axis represents frequency (hertz (Hz)), and a vertical axis represents decibel (dB) of audio data. Furthermore, in FIG. 3, a curve L1 represents audio data (first audio data) before noise removal, and a curve L2 represents audio data (second audio data) after noise removal. In FIG. 3, target voice is set to 1 kilohertz (kHz).

According to the first embodiment described above, the arithmetic unit 5 generates the third data by synthesizing the first data input from the first converting unit 2 in which no musical noise has been generated and the second data input from the subtracting unit 3 in which no musical noise has been generated, or includes only a small amount of musical noise even if it has been generated and, therefore, it is possible to suppress generation of musical noise while suppressing deterioration of audio data.

Moreover, according to the first embodiment, as for the noise removal, for example, as shown by the curve L1 and the curve L2 in FIG. 3 described above, a signal-to-noise (SN) ratio after noise removal has improved by 6 dB at 1 kHz. As described, according to the noise reduction apparatus 1, it is possible to remove noise, suppressing generation of musical noise, while maintaining target voice.

### Second Embodiment

Next, a second embodiment is described. The second embodiment is an electronic device that is equipped with the noise reduction apparatus 1 according to the first embodiment described above. Accordingly, in the following, a configuration of an electronic device according to the second embodiment is described, and then processing performed by the electronic device according to the second embodiment is described. like reference symbols are given to like components with the noise reduction apparatus 1 according to the first embodiment described above, and detailed description is omitted.

### Configuration of Electronic Device

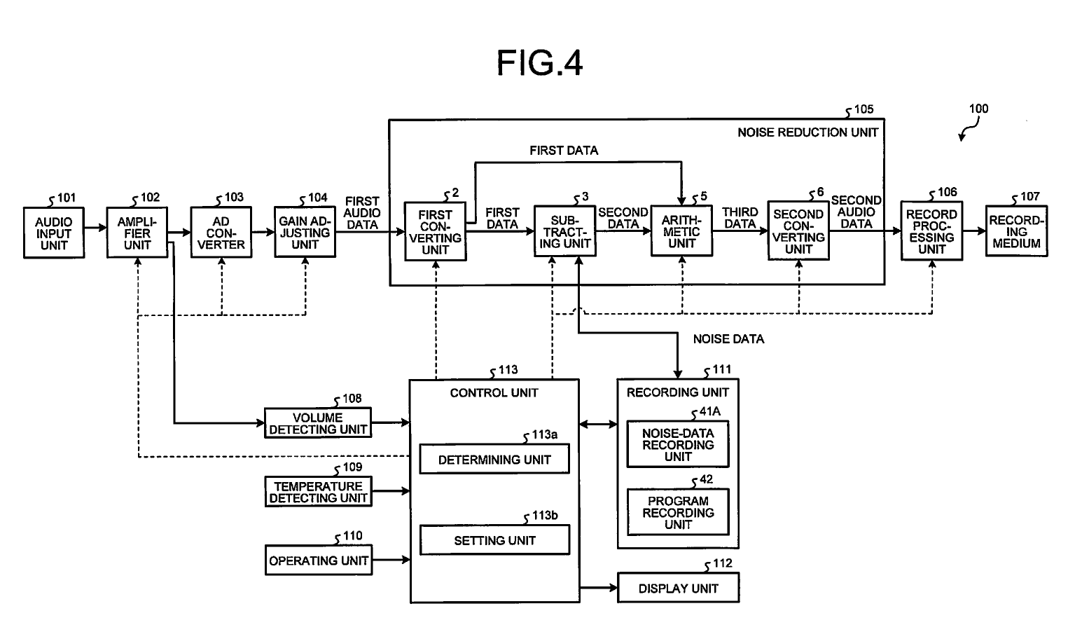

FIG. 4 is a block diagram illustrating a functional configuration of the electronic device according to the second embodiment. An electronic device 100 illustrated in FIG. 4 includes an audio input unit 101, an amplifier unit 102, an analog/digital (AD) converter 103, a gain adjusting unit 104, a noise reduction unit 105, a record processing unit 106, a recording medium 107, a volume detecting unit 108, a temperature detecting unit 109, an operating unit 110, a recording unit 111, a display unit 112, and a control unit 113.

The audio input unit 101 receives input of voice to convert into an analog audio signal (electrical signal), and outputs this audio signal to the amplifier unit 102. The audio input unit 101 is constituted of a directive microphone, a stereo microphone, or the like.

The amplifier unit 102 amplifies the analog audio signal input from the audio input unit 101 with a predetermined amplification factor to output to the AD converter 103 under control of the control unit 113. The amplifier unit 102 is constituted of an amplification amplifier, or the like.

The AD converter 103 subjects the analog audio signal input from the amplifier unit 102 to AD conversion processing, to generate audio data with a predetermined bit number, for example, first audio data (quantized data) of 16 bits or 24 bits, under control of the control unit 113. The AD converter 103 is constituted of an AD converter circuit, or the like.

The gain adjusting unit 104 adjusts a gain of the first audio data under control of the control unit 113, to output to the noise reduction unit 105. The gain adjusting unit 104 is constituted of a gain adjuster circuit, or the like.

The noise reduction unit 105 subjects the first audio data input from the gain adjusting unit 104 to noise reduction processing of reducing noise, to output to the record processing unit 106 under control of the control unit 113. The noise reduction unit 105 includes the first converting unit 2, the second subtracting unit 3, the arithmetic unit 5, and the second converting unit 6 of the noise reduction apparatus 1 according to the first embodiment described above.

The record processing unit 106 stores the second audio data input from the noise reduction unit 105 in an audio file of a predetermined format to record it in the recording medium 107, under control of the control unit 113. The record processing unit 106 stores the second audio data in an audio file of either one of audio formats of, for example, MPs, WAV, AIFF, FLAC, MPEG4, and the like, to record in the recording medium 107. The record processing unit 106 is constituted of, for example, an audio codec, or the like.

The recording medium 107 is externally attachable to the electronic device 100, and stores audio file input from the record processing unit 106, or the like. The recording medium 107 is constituted of, for example, a memory card, or the like.

The volume detecting unit 108 detects volume of voice based on a voltage value of the analog audio signal input from the amplifier unit 102, and outputs this detection result to the control unit 113. The volume detecting unit 108 is constituted of, for example, a voltmeter, a voltage detection circuit, or the like.

The temperature detecting unit 109 detects temperature around the electronic device 100, and outputs this detection result to the control unit 113. The temperature detecting unit 109 is constituted of a temperature sensor, or the like.

The operating unit 110 accepts input of an instruction signal to instruct various kinds of operations relating to the electronic device 100, and outputs this accepted instruction signal to the control unit 113. The operating unit 110 accepts a start signal to instruct start of recording to the electronic device 100, an end signal to instruct end of recording, a switch signal to switch any one of plural modes (for example, record mode A, record mode B, and the like) in which the electronic device 100 may operate, an adjustment signal to adjust a gain of audio data, and the like. The operating unit 110 is constituted of a button, a switch, a toggle switch, a touch panel, and the like.

The recording unit 111 is constituted of a flash memory, a synchronous dynamic random-access memory (SDRAM), or the like. The recording unit 4 includes a noise-data recording unit 41A in which noise data used for subtraction by the subtracting unit 3 is recorded, and a program recording unit 42 in which various kinds of programs executed by the noise reduction apparatus 1 are recorded.

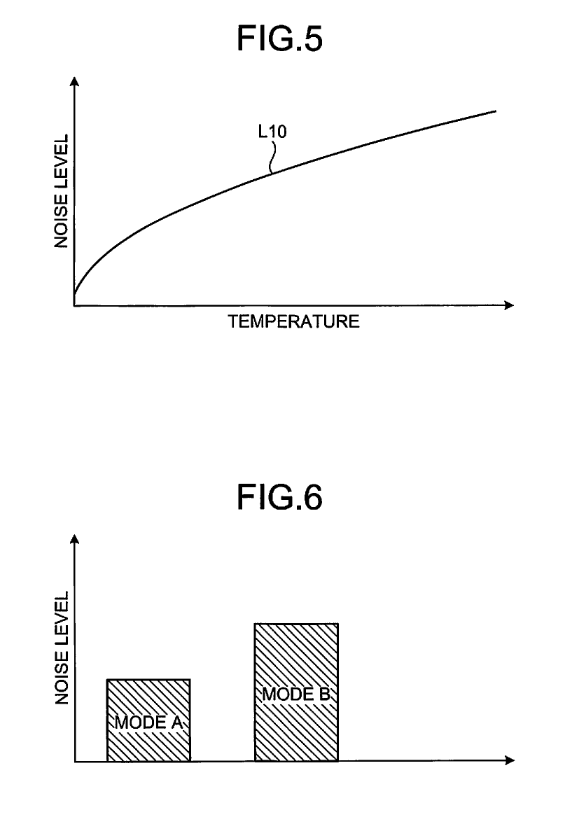

FIG. 5 is a schematic diagram illustrating an example of noise data that is recorded in the noise-data recording unit 41A. In FIG. 5, a horizontal axis represents temperature, a vertical axis represents noise level, and a curve L10 represents a relationship between a temperature and a noise level. As shown in the curve L1 in FIG. 5, the noise-data recording unit 41A records a noise level per temperature. In FIG. 5, noise levels are continuously associated with all temperatures, but not limited thereto, noise levels and temperatures may be recorded, discretely associating noise levels and temperatures.

FIG. 6 is a schematic diagram illustrating another example of noise data recorded in the noise-data recording unit 41A. In FIG. 6, a horizontal axis represents mode type, and a vertical axis represents noise level. As illustrated in FIG. 6, the noise-data recording unit 41A records a noise level for each of the plural modes in which the electronic device 100 operates. In FIG. 6, only two modes are shown, but not limited thereto, noise data may be recorded for each of plural modes, such as an imaging mode, a special-effects imaging mode, a moving image mode, a live recording mode, and a conference mode.

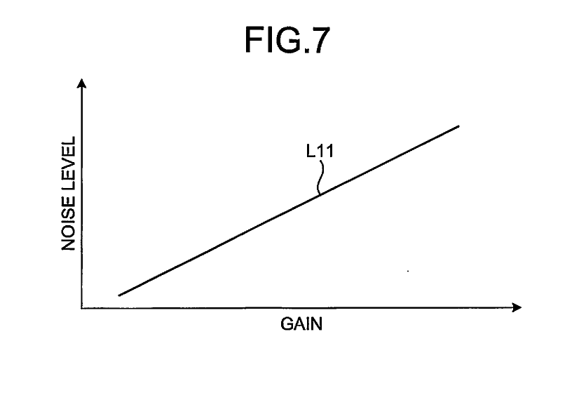

FIG. 7 is a schematic diagram illustrating another example of noise data recorded in the noise-data recording unit 41A. In FIG. 7, a horizontal axis represents gain, a vertical axis represents noise level, and a straight line L11 represents relationship between a gain and a noise level. As shown in the line L11 in FIG. 7, the noise-data recording unit 41A records a noise level for each gain. In FIG. 7, the gain and the noise level are continuously associated with each other, but not limited thereto, the noise level and the gain may be recorded in a discretely associated manner.

Referring back to FIG. 4, description of the configuration of the electronic device 100 is continued.

The display unit 112 displays various kinds of information relating to the electronic device 100 under control of the control unit 113. For example, the display unit 112 displays various kinds of modes, gain value, and the like relating to the electronic device 100 under control of the control unit 113. The display unit 112 is constituted of a liquid crystal or an organic electroluminescence (EL) display panels, or the like.

The control unit 113 performs overall control of the respective components of the electronic device 100. The control unit 113 is constituted of, for example, a CPU, an FPGA, an ASIC, or the like. The control unit 113 includes a determining unit 113a and a setting unit 113b.

The determining unit 113a determines (selects) a noise level that is used by the subtracting unit 3 from noise data recorded in the noise-data recording unit 41A. Specifically, the determining unit 113a determines a noise level when the gain adjusting unit 104 subjects the first data to gain adjustment based on the noise data recorded by the noise-data recording unit 41A and the gain adjusted for the first audio data by the gain adjusting unit 104. (refer to FIG. 7) Moreover, the determining unit 113a a noise level corresponding to current temperature based on temperature detected by the temperature detecting unit 109 and noise data recorded by the noise-data recording unit 41A (refer to FIG. 5). Furthermore, the determining unit 113a determines a noise level based on a type of mode set according to the operating unit 110 and noise data recorded by the noise-data recording unit 41A (refer to FIG. 6). Note that the determining unit 113a may determine a noise level by selecting any one of the gain adjusted by the gain adjusting unit 104, the temperature detected by the temperature detecting unit 109, and the mode set according to the operating unit 110. The determining unit 113a may, of course, may determine a noise level by selecting a highest noise level among a gain adjusted by the gain adjusting unit 104, temperature detected by the temperature detecting unit 109, and a mode set according to the operating unit 110, or by selecting a lowest noise level there among. Furthermore, the determining unit 113a may determine a noise level by selecting an average of respective noise levels of a gain adjusted by the gain adjusting unit 104, temperature detected by the temperature detecting unit 109, and a mode set according to the operating unit 110.

The setting unit 113b sets a coefficient by which each of the first data and the second data is to be multiplied by the arithmetic unit 5 based on volume of the first audio data. Specifically, the setting unit 113b sets a coefficient by which each of the first data and the second data is multiplied by the arithmetic unit 5 based on a voltage value of the audio signal.

### Processing by Electronic Device

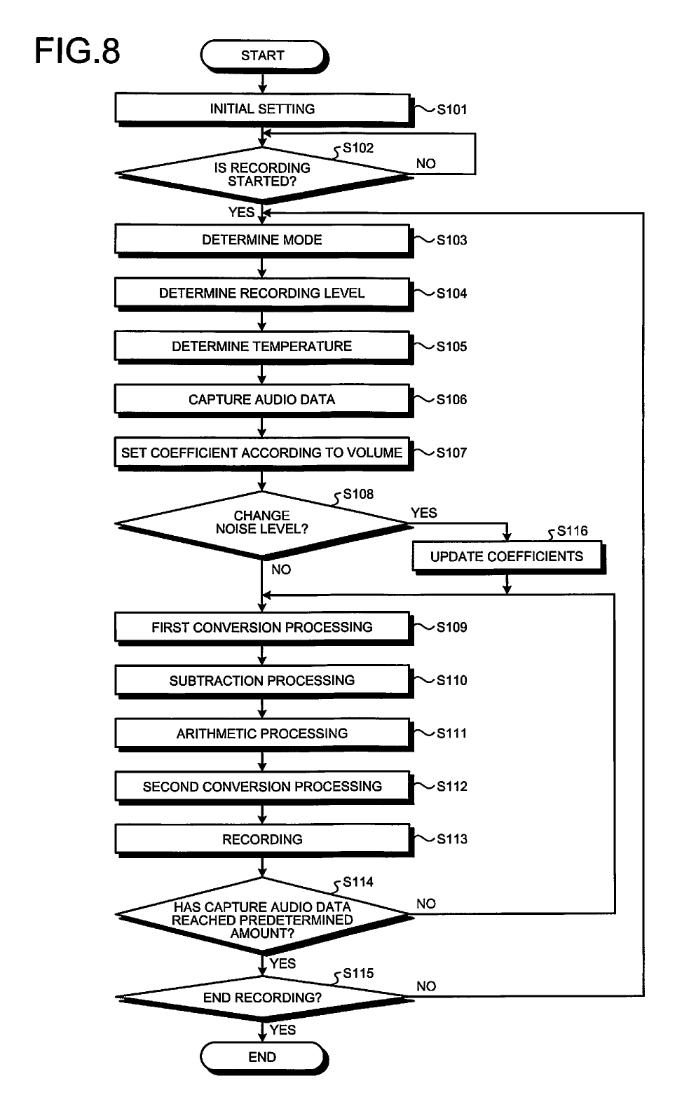

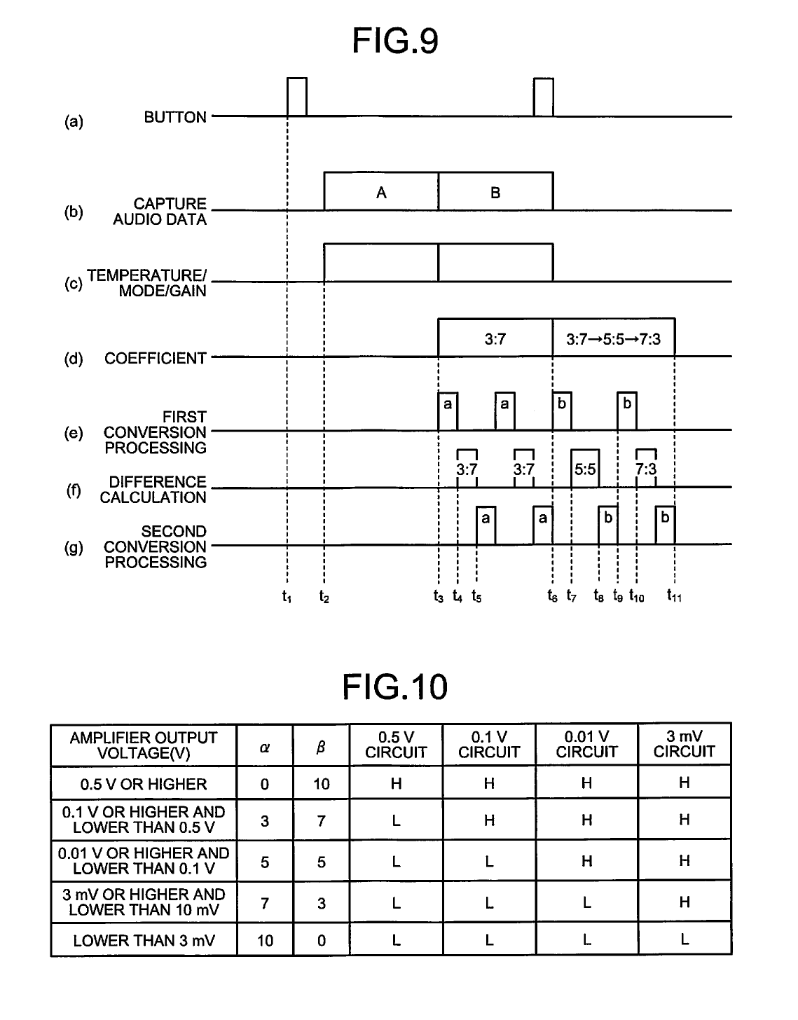

Next, processing performed by the electronic device 100 is described. FIG. 8 is a flowchart illustrating an overview of the processing performed by the electronic device 100. FIG. 9 is a timing chart of an action performed by the electronic device 100.

As illustrated in FIG. 8, first, the control unit 113 makes various kinds of initial settings relating to the electronic device 100 when a power button of the operating unit 110 is operated and the electronic device 100 is activated (step S101). The initial settings include checking whether an audio file recorded in the recording medium 107 is present, checking a remaining battery power, date setting, and the like.

Subsequently, when the operating unit 110 is operated and a start signal is input, and recording of a voice is started (step S102: YES), the determining unit 113a determines the mode of the electronic device 100 (step S103), and determines a recording level (gain) of the electronic device set according to operations of the operating unit 110 (step S104), and determines temperature based on a result of detection by the temperature detecting unit 109 (step S105). At this time, the audio input unit 101 captures recorded data (step S106), and the setting unit 113b sets a coefficient according to volume detected by the volume detecting unit 108 (step S107). Specifically, as illustrated in FIG. 9, when a record button of the operating unit 110 is operated and a start signal is input (time t₁), the audio input unit 101 captures recording data, and the determining unit 113a determines a noise level to be used by the subtracting unit 3 by using noise data recorded by the noise-data recording unit 41A, and any one of the mode of the electronic device 100, the recording level (gain), and the temperature (temperature t₂). Furthermore, as illustrated in (b) in FIG. 9, the setting unit 113b sets a coefficient (for example, 3:7) according to volume detected by the volume detecting unit 108 to data in a predetermined section, such as A and B (time t₃).

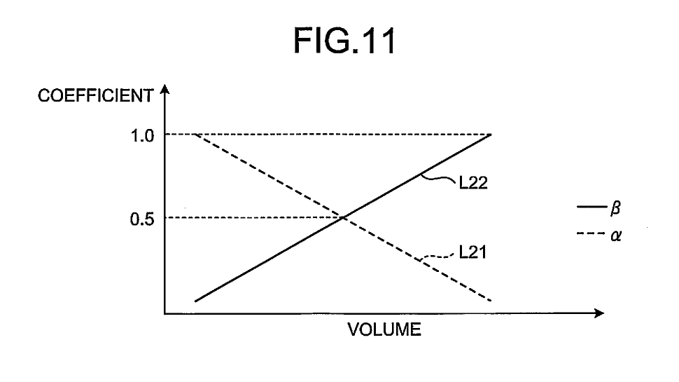

FIG. 10 is a schematic diagram of a coefficient that is set to each of the first data and the second data according to volume detected by the volume detecting unit 108 by a setting unit 113b. FIG. 11 is a schematic diagram illustrating a coefficient according to volume of each of the first data and the second data. In FIG. 11, a horizontal axis represents volume, and a vertical axis represents a coefficient. Moreover, in FIG. 11, a straight line L21 represents a coefficient α by which the first data is multiplied, and a straight line L22 represents a coefficient β by which the second data is multiplied.

As illustrated in FIG. 10 and FIG. 11, the setting unit 113b sets a coefficient such that the ratio of the second data increases as volume increases, and such that the ratio of the first data increases as volume decreases. Specifically, as illustrated in FIG. 9 to FIG. 11, the setting unit 113b sets coefficients according to volume detected by the volume detecting unit 108, for example, coefficients by which the first data and the second data are respectively multiplied to 3:7, for example, when the number of digital signals of “H” (high level) output from respective circuits of the volume detecting unit 108 is three (time t₃). The respective circuits are comparator circuits that output a digital signal of “H” (high level) at a predetermined voltage or higher, and that output a digital signal of “L” (low level) at a voltage lower than the predetermined voltage.

Referring back to FIG. 8, description at step S108 and later is continued.

At step S108, when a noise level to be used by the subtracting unit 3 is changed (step S108: YES), the electronic device 100 shifts to step S116 described later. On the other hand, when a noise level to be used by the subtracting unit 3 is not changed (step S108: NO), the electronic device 100 shifts to step S109 described later.

At step S109, the first converting unit 2 generates the first data by subjecting the first audio data that is input from the gain adjusting unit 104 to the Fourier transform to convert into amplitude data per frequency, and outputs this first data to the subtracting unit 3 and the arithmetic unit 5. Specifically, as illustrated in FIG. 9, the first converting unit 2 generates the first data (first data a) by subjecting the first audio data that is input from the gain adjusting unit 104 to the Fourier transform to convert into amplitude data per frequency, and outputs this first data to the subtracting unit 3 and the arithmetic unit 5 (time t₃).

Thereafter, the subtracting unit 3 generates the second data by subtracting noise data according to a result of determination by the determining unit 113a from the first data (the first data a) input from the first converting unit 2 (step S110). The arithmetic unit 5 generates the third data by synthesizing the first data input from the first converting unit 2 and the second data input from the subtracting unit 3 by multiplying by the coefficients set by the setting unit 113b, respectively (step S111). Specifically, as illustrated in FIG. 9, the arithmetic unit 5 generates the third data based on the first data, the second data, and the respective coefficients (for example, 3:7) (time t₄). In this case, the arithmetic unit 5 generates third data γ by following Equation (1) where the coefficient by which the first data is multiplied is α, and the coefficient by which the second data is multiplied is β.

γ=(first data×α+second data×β)/(α+β) (1)

After step S111, the second converting unit 6 converts the third data into audio data by subjecting the third data input from the arithmetic unit 5 to the inverse Fourier transform (step S112). Specifically, as illustrated in FIG. 9, the second converting unit 6 converts the third data into audio data by subjecting the third data input from the arithmetic unit 5 to the inverse Fourier transform (time t₅). Thus, the musical noise may be suppressed.

Subsequently, the control unit 113 causes the record processing unit 106 to record the audio data generated by the second converting unit 6 in the recording medium 107 (step S113).

Thereafter, when an amount of audio data captured by the audio input unit 101 reaches a predetermined amount (step S114: YES), the electronic device 100 shifts to step S115 described later. On the other hand, when an amount of audio data captured by the audio input unit 101 has not reached the predetermined amount (step S114: NO), the electronic device 100 returns to step S109 described above.

At step S115, when the operating unit 110 is operated and an end signal to end recording is input (step S115: YES), the electronic device 100 ends this processing. On the other hand, when the operating unit 110 is operated, and an end signal to end recording has not been input (step S115: NO), the electronic device 100 returns to step S113 described above.

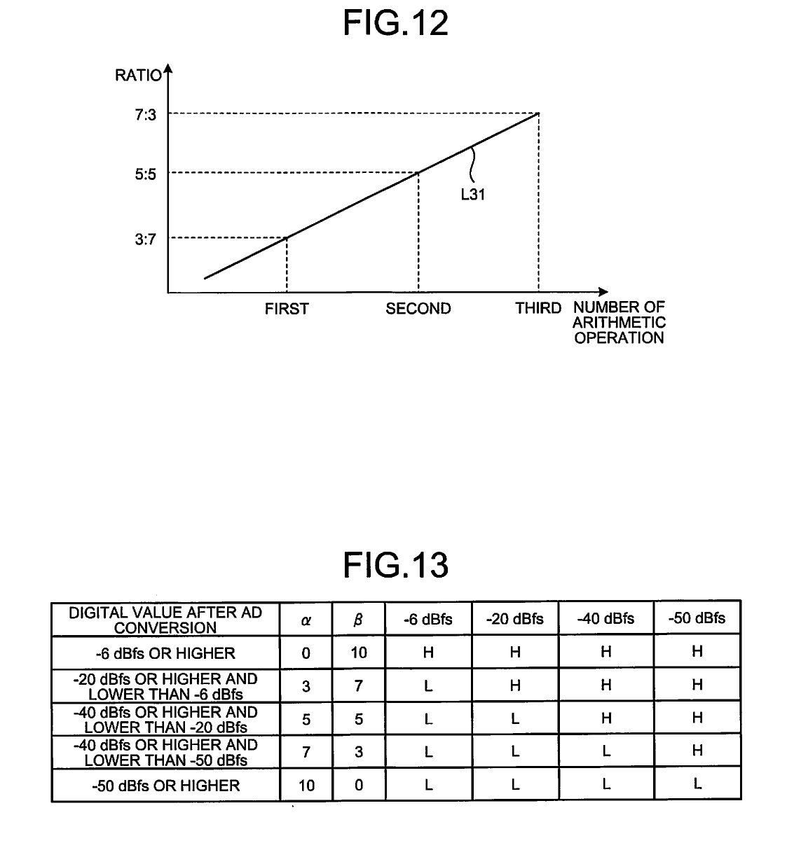

At step S116, when volume detected by the volume detecting unit 108 varies, the setting unit 113b updates the coefficient used when synthetizing the first data and the second data by the arithmetic unit 5 according to the volume. After step S116, the electronic device 100 shifts to step S109. In this case, as illustrated in FIG. 9 and FIG. 12, when the setting unit changes the coefficients by which the first data and the second data are multiplied from 3:7 to 7:3, the arithmetic unit 5 generates the third data while changing the coefficients by which the first data and the second data are multiplied, gradually increasing the coefficients at each arithmetic operation (3:7→5:5→7:3) time t₆ to time t₁₁). As described, the electronic device 100 repeats steps S103 to step S114 described above until recording is ended, and generates the third data while changing noise levels and coefficients for the each of the first data and the second data as needed. Accordingly, the third data in which changes are smooth may be generated and, therefore, noise is suppressed without awkwardness, while suppressing deterioration of audio data.

According to the second embodiment described above, the arithmetic unit 5 generates third data by synthesizing first data that is input from the first converting unit 2 and second data that is input from the subtracting unit 3 by multiplying by coefficients of predetermined ratio, respectively, to assign weights and, therefore, occurrence of noise and musical noise may be suppressed without deteriorating audio data.

Moreover, according to the second embodiment, the arithmetic unit 5 assigns weights to the first data that is input from the first converting unit 2 and the second data that is input from the subtracting unit 3 by multiplying by coefficients set by the setting unit, respectively. Accordingly, third data in which changes are smooth may be generated without awkwardness, and noise may be suppressed.

Furthermore, according to the second embodiment, the subtracting unit 3 removes noise data from first audio data by using a noise level determined by the determining unit 113a. Accordingly, noise that occurs according to environments, such as temperature, mode, and gain, may be suppressed.

In the second embodiment, the volume detecting unit 108 detects volume based on a voltage value of an audio signal that is output from the amplifier unit 102, but not limited thereto, for example, the volume detecting unit 108 may detect volume based on a digital value of digital audio data that is output by the AD converter 103 as illustrated in FIG. 13.

### Third Embodiment

Next, a third embodiment is described. The third embodiment has the same configuration as the electronic device 100 according to the second embodiment described above, but processing performed therein is different. Specifically, in the third embodiment, while capturing audio data in real time, the first data and the second data are synthesized, updating the coefficients by which the first data and the second data are multiplied in real time. In the following, processing performed by an electronic device according to the third embodiment is described. Like reference symbols are given to like components with the electronic device 100 according to the second embodiment described above, and detailed description is omitted.

### Processing by Electronic Device

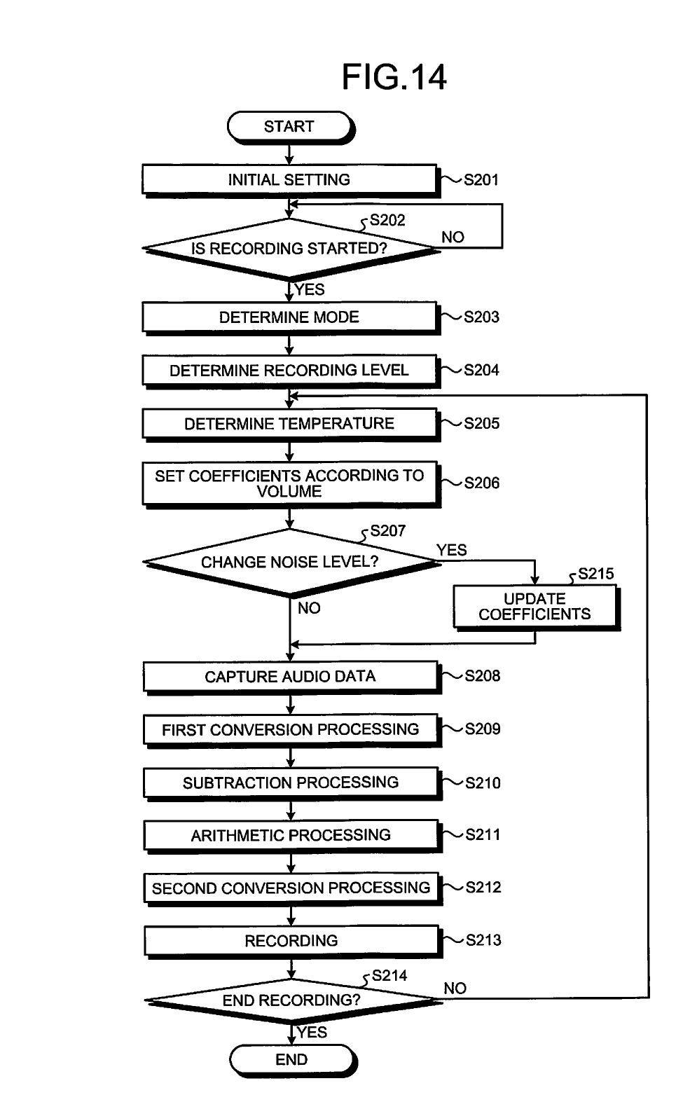

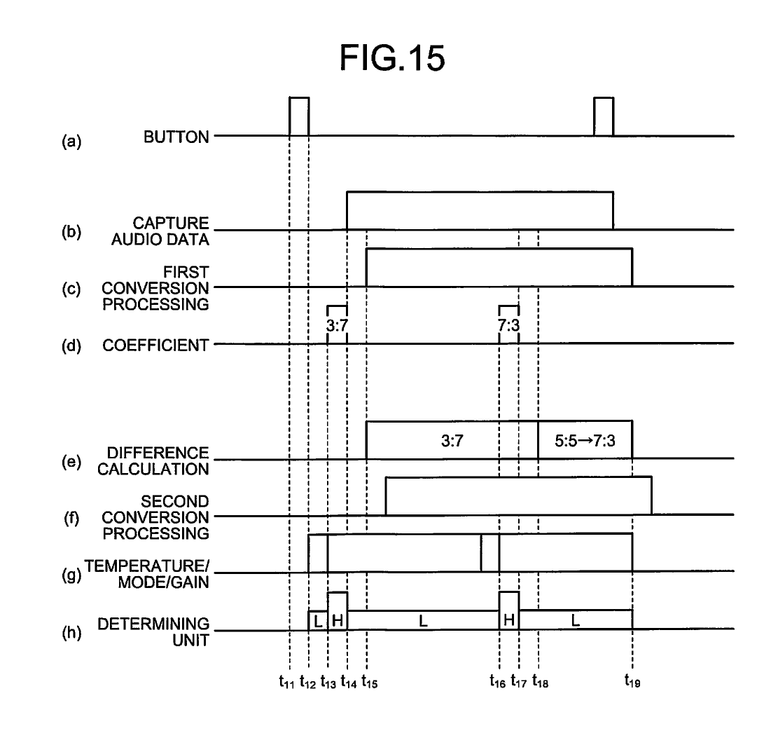

FIG. 14 is a flowchart illustrating an overview of processing performed by the electronic device 100 according to the third embodiment. FIG. 15 is a timing chart of an action performed by the electronic device 100 according to the third embodiment.

In FIG. 14, step S201 to step S205 correspond to step S101 to S105 described above, respectively. Step S206 and step S207 correspond to step S107 and step S108 described above, respectively. In this case, as illustrated in FIG. 15, the determining unit 113a determines noise levels sequentially (for example, time t₁₂, t₁₃, t₁₄). Furthermore, the setting unit 113b sets the coefficients, for example, to 3:7 (time t₁₃).

At step S208, the audio input unit 101 captures audio data. Specifically, as illustrated in FIG. 15, the audio input unit 101 captures audio data sequentially (time t₁₄). In this case, the first converting unit 2 subjects the audio data captured by the audio input unit 101 to first conversion processing sequentially (time t₁₄). Furthermore, the determining unit 113a performs determination sequentially, and the setting unit 113b determines coefficients. Furthermore, each of the subtracting unit 3 and the arithmetic unit 5 also performs arithmetic operation (time t₁₅). In this case, the setting unit 113b outputs a signal (High) indicating that coefficients are changed when volume detected by the volume detecting unit 108 varies (time t₁₆).

Step S209 to step S213 correspond to step S109 to step S113 in FIG. 8 described above, respectively. In this case, as illustrated in FIG. 15, step S214 and step S215 correspond to step S115 and step S116 in FIG. 8 described above, respectively. In this case, as illustrated in FIG. 15, when the setting unit 113b gradually changes coefficients by which the first data and the second data are multiplied from 3:7 to 7:3, the arithmetic unit 5 generates the third data while changing the coefficients by which the first data and the second data are multiplied (3:7→5:5→7:3), gradually increasing the coefficients at each operation (time t₁₆→time t₁₇→time t₁₇→time t₁₉). Accordingly, the third data in which changes are smooth may be generated and, therefore, noise may be suppressed without awkwardness.

According to the third embodiment described above, the arithmetic unit 5 may generate the third data in which changes are smooth because the arithmetic unit 5 assigns weights by multiplying the first data input from the first converting unit 2 and the second data input from the subtracting unit 3 by coefficients sequentially set by the setting unit 113b, respectively, and noise may be suppressed without awkwardness.

Furthermore, according to the third embodiment, the arithmetic unit 5 generates the third data by synthesizing the first data input from the first converting unit 2 and the second data input from the subtracting unit 3 by multiplying coefficients of a predetermined ratio, respectively, to assign weights and, therefore, occurrence of noise and musical noise may be suppressed without deteriorating audio data.

### Fourth Embodiment

Next, a fourth embodiment is described. The fourth embodiment has the same configuration as the electronic device according to the third embodiment, but processing performed therein is different. Specifically, the electronic device 100 according to the third embodiment described above sequentially changes coefficients by which the first data and the second data are respectively multiplied in real time, but in the fourth embodiment, coefficients by which the first data and the second data are respectively multiplied are changed every predetermined time. In the following, processing performed by an electronic device according to the fourth embodiment is described. Like reference symbols are given to like components with the electronic device 100 according to the third embodiment described above, and detailed description is omitted.

### Processing by Electronic Device

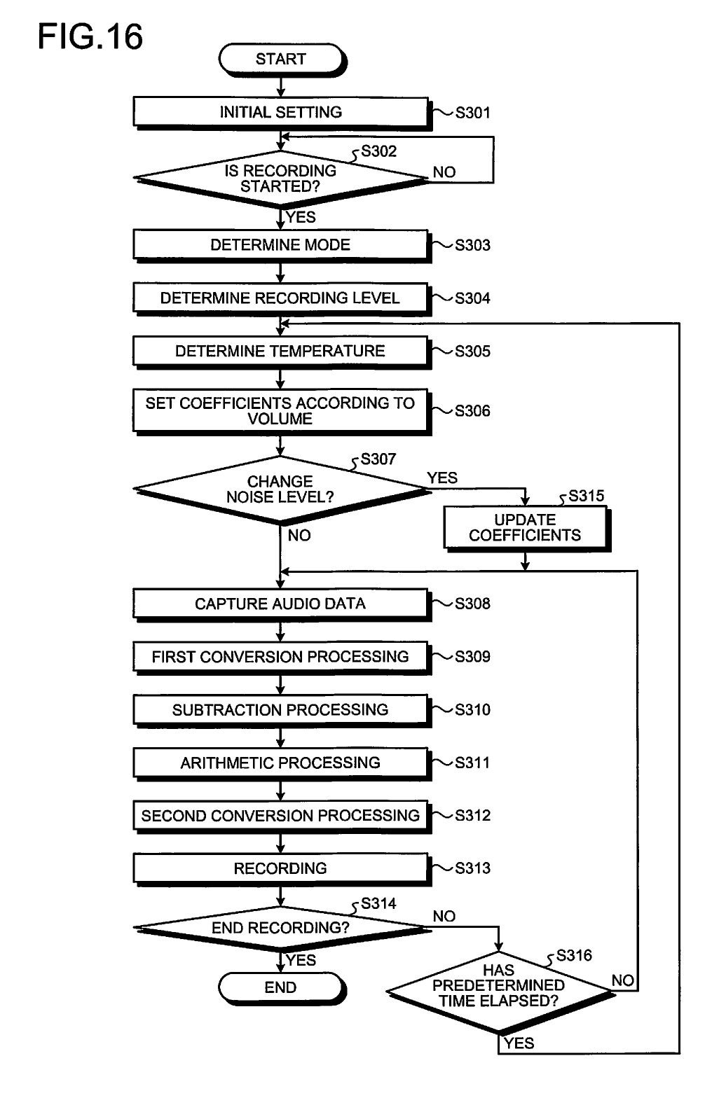

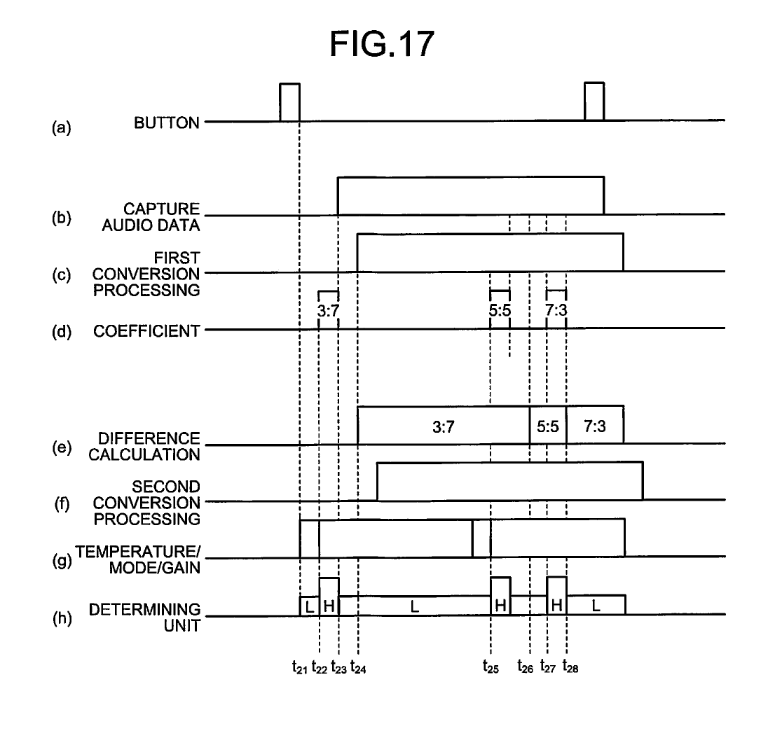

FIG. 16 is a flowchart illustrating an overview of processing performed by an electronic device 100 according to the fourth embodiment. FIG. 17 is a timing chart of an action performed by the electronic device 100 according to the fourth embodiment.

In FIG. 16, step S301 to step S315 corresponds to step S201 to step S215 described above, respectively.

At step S316, when predetermined time has elapsed since recording is started (step S316: YES), the electronic device 100 returns to step S305 described above. On the other hand, when the predetermine time has not elapsed since the recording is started (step S316: NO), the electronic device 100 returns to step S308 described above. In this case, as illustrated in FIG. 17, the setting unit 113b changes coefficients by which the first data and the second data are respectively multiplied every predetermined time (3:7→5:5→7:3), and the arithmetic unit 5 generates the third data while changing the coefficients by which the first data and the second data are respectively multiplied each time the setting unit 113b changes and sets the coefficients in real time t₂₂ to time t₂₈). Accordingly, the third data in which changes are smooth may be generated and, therefore, noise may be suppressed without awkwardness.

According to the fourth embodiment described above, the setting unit 113b determines coefficients every predetermined time, and the arithmetic unit 5 assigns weights to the first data that is input from the first converting unit 2 and the second data that is input from the subtracting unit 3 by multiplying by the coefficients set by the setting unit 113b, respectively. Accordingly, the third data in which changes are smooth may be generated, and noise may be suppressed without awkwardness.

Moreover, according to the fourth embodiment, the arithmetic unit 5 generates the third data by synthesizing the first data input from the first converting unit 2 and the second data input from the subtracting unit 3 by multiplying by coefficients of a predetermined ratio, respectively, to assign weights and, therefore, occurrence of noise and musical noise may be suppressed without deteriorating audio data.

### Other Embodiments

By combining the components disclosed in the first to the fourth embodiments described above as appropriate, various embodiments may be formed. For example, some components out of all of the components described in the first to the fourth embodiments described above may be excluded. Furthermore, the components described in the first to the fourth embodiments described above may be combined as appropriate.

Moreover, in the first to the fourth embodiments, “unit” may be read as “means” or “circuit”. For example, the control unit may be read as control means or control circuit.

Furthermore, the programs that cause the noise reduction apparatus or the electronic device according to the first to the fourth embodiments may be recorded in a computer-readable recording medium, such as a compact-disk read-only memory (CD-ROM), a flexible disk (FD), a compact-disk rewritable (CD-R), a digital versatile disk (DVD), a universal serial bus (USB) medium, and a flash memory, in a form of file data of an installable format or an executable format, to be provided.

Moreover, the programs that cause the noise reduction apparatus or the electronic device according to the first to the fourth embodiments may be configured to be stored in a computer connected to a network, such as the Internet, and to be provided by being downloaded through the network. Furthermore, the programs that are executed by the noise reduction apparatus or the electronic device according to the first to the fourth embodiments may be provided or distributed through a network, such as the Internet.

In the description of the flowcharts in the present disclosure, a sequence of processing among steps has been expressed by using expressions, such as “first”, “thereafter”, and “subsequently”, but the sequence of processing necessary for implementing the present invention is not determined uniquely by those expressions. That is, the sequence of processing in the flowcharts described in the present disclosure may be changed within a range not causing a contradiction. Moreover, not limited to such a program configured with simple branch processing, branching may be performed by generally determining more determination items.

As above, the embodiments have been described in detail based on the drawings, but these are only examples, and the present invention may be implemented by other embodiments in which various modifications and improvements are made based on knowledge of those skilled in the art, including forms described in a section of disclosure of the present invention.

As described, the present disclosure may include various embodiments not described herein, and various alterations in design and the like may be made within a range of specific technical ideas.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A noise reduction apparatus comprising:
a first converting circuit configured to generate first data by subjecting externally input first audio data to Fourier transform to convert into amplitude data per frequency;
a noise-data recording circuit configured to record noise data that has been detected in advance;
a arithmetic circuit configured to generate second data by subtracting the noise data from the first data;
an arithmetic circuit configured to generate third data by synthesizing the first data and the second data; and
a second converting circuit configured to generate second audio data by subjecting the third data to inverse Fourier transform.

2. The noise reduction apparatus according to claim 1, wherein
the arithmetic circuit generates the third data in which the first data and the second data are synthesized by multiplying by coefficients of a predetermined ratio, respectively, to assign weights.

3. The noise reduction apparatus according to claim 2, further comprising
a setting circuit configured to set coefficients by which the first data and the second data are multiplied, respectively, by the arithmetic circuit based on volume of the first audio data.

4. The noise reduction apparatus according to claim 3, wherein
the setting circuit sets the coefficients based on a voltage value of an audio signal corresponding to the first audio data.

5. The noise reduction apparatus according to claim 3, further comprising:
an audio input circuit configured to accept input of voice and outputs an analog audio signal; and
an analog/digital converter circuit configured to generate the first audio data by subjecting the audio signal accepted by the audio input circuit to analog/digital conversion, wherein
the analog/digital converter circuit converts the first audio data at predetermined bit number.

6. The noise reduction apparatus according to claim 1, wherein
the noise data is statistical data that is acquired by statistical calculation of results obtained by subjecting audio data that has been acquired in advance in an anechoic condition to Fourier transform.

7. The noise reduction apparatus according to claim 1 wherein
the noise data is recorded in the noise-data recording circuit in such a manner that a noise level and each temperature, a noise level and each gain with respect to the first audio data, and a noise level and each mode out of a plurality of modes in which the noise reduction apparatus operates are associated with each other.

8. A noise suppressing method that is performed by a noise reduction apparatus that includes a noise-data recording circuit in which noise data detected in advance is recorded, the method comprising:
generating first data by subjecting externally input first audio data to Fourier transform to convert into amplitude data per frequency;
generating second data by subtracting the noise data from the first data;
generating third data by synthesizing the first data and the second data; and
generating second audio data by subjecting the third data to inverse Fourier transform.

9. The noise suppressing method according to claim 8, wherein
the third data in which the first data and the second data are synthesized by multiplying by coefficients of a predetermined ratio, respectively, to assign weights is generated.

10. The noise suppressing method according to claim 9, wherein
the coefficients by which the first data and the second data are multiplied, respectively, are set based on volume of the first audio data.

11. The noise suppressing method according to claim 10, wherein
the coefficients are set based on a voltage value of an audio signal corresponding to the first audio data.

12. The noise suppressing method according to claim 10, further comprising:
accepting input of a voice to output to an analog audio signal; and
generating the first audio data converted at predetermined bit number by subjecting the audio signal to analog/digital conversion.

13. A non-transitory computer-readable recording medium on which an executable program is recorded, the program causes a processor included in a noise reduction apparatus that has a noise-data recording circuit in which noise data detected in advance is recorded to execute:
generating first data by subjecting externally input first audio data to Fourier transform to convert into amplitude data per frequency;
generating second data by subtracting the noise data from the first data;
generating third data by synthesizing the first data and the second data; and
generating second audio data by subjecting the third data to inverse Fourier transform.

14. The recording medium according to claim 13, wherein
the third data in which the first data and the second data are synthesized by multiplying by coefficients of a predetermined ratio, respectively, to assign weights is generated.

15. The recording medium according to claim 14, wherein
the coefficients by which the first data and the second data are multiplied, respectively, are set based on volume of the first audio data.

16. The recording medium according to claim 15, wherein
the coefficients are set based on a voltage value of an audio signal corresponding to the first audio data.

17. The recording medium according to claim 16, wherein the program further causes the processor to execute:
accepting input of a voice to output to an analog audio signal; and
generating the first audio data converted at predetermined bit number by subjecting the audio signal to analog/digital conversion.
